(19) United States
(12) Patent Application Publication
(10) Pub. No.: US 2021/0064019 A1
(43) Pub. Date: Mar. 4, 2021

(54) ROBOT

(71) Applicant: LG ELECTRONICS INC., Seoul (KR)

(72) Inventors: Jeongeun CHOI, Seoul (KR); Seulah LEE, Seoul (KR); Dong Won SEO, Seoul (KR)

(73) Assignee: LG ELECTRONICS INC., Seoul (KR)

(21) Appl. No.: 16/994,443

(22) Filed: Aug. 14, 2020

(30) Foreign Application Priority Data
Aug. 30, 2019 (KR) PCT/KR2019/011191

(51) Int. Cl. G05D 1/00; G05D 1/02; G01S 17/931; G06N 3/04

(52) U.S. Cl. CPC G05D 1/0016; G05D 1/0246; G05D 1/0088; G05D 1/0221; G06N 3/04; G01S 17/931

(57) ABSTRACT

A robot includes a container and determines whether the robot has entered a target area using a learning model based on an artificial neural network, and upon entering the target area, the robot switches to a mode capable of unlocking a container.

### CROSS-REFERENCE TO RELATED APPLICATION

This application claims the priority benefit of International Application No.: PCT/KR2019/011191 filed on Aug. 30, 2019, the entirety of which is hereby expressly incorporated by reference into the present application.

### BACKGROUND

### 1. Technical Field

The present disclosure relates to a robot, and more particularly to a robot capable of unlocking a container in a target area and a method of controlling the same.

### 2. Description of Related Art

In recent years, a transport service using a robot has been provided in various places, such as an airport, a hospital, a shopping mall, a hotel, and a restaurant. An airport robot moves baggage/luggage and other items for people. A hospital robot safely delivers dangerous chemicals. A concierge robot provides room service requested by guests, and a serving robot serves food, including hot food in a heated state.

Korean Patent Application Publication No. KR 10-2019-0055415 A discloses a ward assistant robot device that delivers articles necessary for medical treatment of patients. Here, the ward assistant robot device moves to the front of a bed of a patient while carrying necessary articles, and provides the articles for treatment of the patient to a doctor in charge.

Korean Patent Registration No. KR 10-1495498 B1 discloses an auxiliary robot for patient management that delivers medicine packets containing medicine to be taken by patients. To this end, the auxiliary robot for patient management divides medicine by patient, puts medicine in the packets, and unlocks a receiver assigned to a patient who is recognized as a recipient.

In the technologies disclosed in the above related art, however, the receiver is unlocked through an authentication of a doctor or a patient only at a specific destination, and therefore it is necessary for the robot to arrive at the destination in order to complete delivery. When a plurality of people or obstacles are present near the destination, it is necessary to reduce the driving speed of the robot and to perform collision-avoidance driving, whereby delivery may be delayed.

### SUMMARY OF THE DISCLOSURE

An aspect of the present disclosure is to address a shortcoming associated with some related art in which delivery of an article is delayed when it is difficult for a robot to approach a destination, such as when a plurality of people or obstacles are present near the destination.

Another aspect of the present disclosure is to provide a robot that switches to an operation mode capable of unlocking a container of the robot when approaching a destination.

A further aspect of the present disclosure is to provide a robot that determines whether the robot has entered a target area using an object recognition model based on an artificial neural network.

Aspects of the present disclosure are not limited to those mentioned above, and other aspects not mentioned above will become evident to those skilled in the art from the following description.

A robot according to an embodiment of the present disclosure performs switching to a ready to unlock mode when the robot enters a target area near a destination. The target area encompasses the destination and includes an area around the destination. The target area may include (e.g., extend) a predetermined radius or distance (e.g., reference distance) around (e.g., from) the destination. That is, the robot may automatically switch from a lock mode to the ready to unlock mode when the robot enters the target area.

To this end, a robot according to an embodiment of the present disclosure, may include at least one container, a memory configured to store route information from a departure point to a destination, a sensor configured to acquire, based on the route information, space identification data (identification data of the space the robot is located in) while the robot is driving, and a processor (e.g., CPU, controller) configured to control opening and closing of the container according to an operation mode. The memory may be a non-transitory computer readable medium comprising computer executable program code configured to instruct the processor to perform functions.

Specifically, the processor may be configured to determine whether the robot has entered a target area capable of unlocking the container based on acquired space identification data and to set the operation mode to a ready to unlock mode upon determining that the robot has entered the target area.

To this end, the processor may be configured to determine whether the robot has entered the target area using an object recognition model based on an artificial neural network.

The robot, according to the embodiment of the present disclosure, may further include a display configured to display a user interface screen.

A method of controlling a robot having a container according to an embodiment of the present disclosure may include acquiring target area information of a target area capable of unlocking the container, of locking the container and of setting an operation mode to a lock mode, acquiring space identification data while the robot is driving based on route information from a departure point to a destination, determining whether the robot has entered a target area near the destination based on the space identification data, and setting the operation mode to a ready to unlock mode upon determining that the robot has entered the target area.

The method according to the embodiment of the present disclosure may further include, when the operation mode is the ready to unlock mode, displaying a lock screen configured to receive input for unlocking through a display.

The method according to the embodiment of the present disclosure may further include transmitting a notification message to an external device when the robot has entered the target area.

Other embodiments, aspects, and features in addition to those described above will become clear from the accompanying drawings, the claims, and the detailed description of the present disclosure.

According to embodiments of the present disclosure, it is possible to prevent a decrease in the driving speed of the robot, which occurs when a plurality of people or obstacles is present near the destination.

In addition, it is possible to reduce delay time required to accurately arrive at the destination due to avoidance driving, thereby improving user convenience.

In addition, it is possible to determine whether the robot has entered the target area using the object recognition model based on the artificial neural network, thereby improving accuracy.

It should be noted that effects of the present disclosure are not limited to the effects of the present disclosure as mentioned above, and other unmentioned effects of the present disclosure will be clearly understood by those skilled in the art from an embodiment described below.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram showing an example of a robot control environment including a robot, a terminal, a server, and a network that interconnects the same according to an embodiment.

FIG. 2 is a perspective view of a robot according to an embodiment.

FIG. 3 is a block diagram of the robot according to an embodiment.

FIG. 4 is a diagram showing switching between operation modes of the robot according to the embodiment.

FIG. 5 is a flowchart of a robot control method according to an embodiment.

FIG. 6 is a diagram showing an example of a user interface screen based on the operation mode.

FIG. 7 is a block diagram of a server according to an embodiment.

### DETAILED DESCRIPTION

Hereinafter, embodiments disclosed herein will be described in detail with reference to the accompanying drawings, and the same reference numerals are given to the same or similar components and duplicate descriptions thereof will be omitted. Also, in describing an embodiment disclosed in the present document, if it is determined that a detailed description of a related art incorporated herein unnecessarily obscure the gist of the embodiment, the detailed description thereof will be omitted.

The terminology used herein is used for the purpose of describing particular exemplary embodiments only and is not intended to be limiting. As used herein, the articles “a,” “an,” and “the,” include plural referents unless the context clearly dictates otherwise. In the description, it should be understood that the terms “include” or “have” indicate existence of a feature, a number, a step, an operation, a structural element, parts, or a combination thereof, and do not previously exclude the existences or probability of addition of one or more another features, numeral, steps, operations, structural elements, parts, or combinations thereof. Furthermore, terms such as “first,” “second,” and other numerical terms may be used herein only to describe various elements, but these elements should not be limited by these terms. These terms are only used to distinguish one element from another.

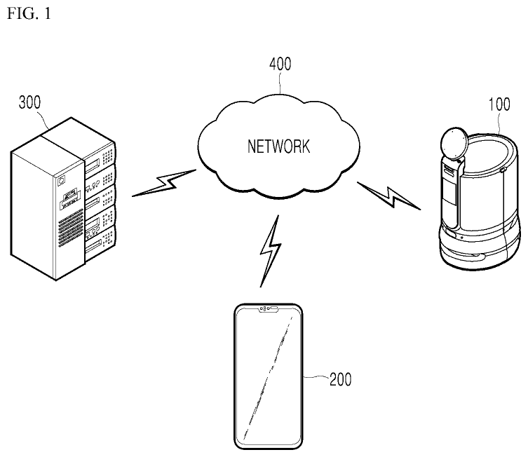

FIG. 1 is a diagram showing an example of a robot control environment including a robot, a terminal, a server, and a network that interconnects the same according to an embodiment. Referring to FIG. 1, the robot control environment may include a robot 100, a terminal 200 (e.g., a mobile terminal or the like), a server 300, and a network 400. Various electronic devices other than the devices shown in FIG. 1 may be interconnected through the network 400 and operated.

The robot 100 may refer to a machine which automatically handles a given task by its own ability, or which operates autonomously. In particular, a robot having a function of recognizing an environment and performing an operation according to its own determination may be referred to as an intelligent robot.

The robot 100 may be classified into industrial, medical, household, military or any other field/classification, according to the purpose or field of use.

The robot 100 may include an actuator (e.g., an electrical actuator, hydraulic actuator, or the like) or a driver including a motor in order to perform various physical operations, such as moving joints of the robot. Moreover, a movable robot may include, for example, at least one wheel, at least one brake, and at least one propeller in the driver thereof, and through the driver may thus be capable of traveling on the ground or flying in the air. That is, the at least one propeller provides propulsion to the robot to allow the robot to fly.

By employing artificial intelligence (AI) technology, the robot 100 may be implemented as a guide robot, a transport robot, a cleaning robot, a wearable robot, an entertainment robot, a pet robot, or an unmanned flying robot (or any other type of robot).

The robot 100 may include a robot control module (e.g., a CPU, processor) for controlling its motion. The robot control module may correspond to a software module or a chip that implements the software module in the form of a hardware device.

Using sensor information obtained from various types of sensors, the robot 100 may obtain status information of the robot 100, detect (recognize) the surrounding environment and objects, generate map data, determine a movement route and drive plan, determine a response to a user interaction, or determine an operation.

Here, in order to determine the movement route and drive plan, the robot 100 may use sensor information obtained from at least one sensor among a light detection and ranging (lidar) sensor, a radar, and a camera.

The robot 100 may perform the operations above by using a learning model configured by at least one artificial neural network. For example, the robot 100 may recognize the surrounding environment, including objects in the surrounding environment by using the learning model, and determine its operation by using the recognized surrounding environment information and/or object information. Here, the learning model may be trained by the robot 100 itself or trained by an external device, such as the server 300.

At this time, that is, once the robot 100 determines its operation by using the recognized surrounding environment information and/or object information, the robot 100 may perform the operation by generating a result by employing the learning model directly. Further, the robot 100 may also perform the operation by transmitting sensor information to an external device, such as the server 300 and receiving a result from the server 300 (the result being generated by the server).

The robot 100 may determine the movement route and drive plan by using at least one of object information detected from the map data and sensor information or object information obtained from an external device, and drive according to the determined movement route and drive plan by controlling its driver.

The map data may include object identification information about various objects disposed in the space in which the robot 100 drives. For example, the map data may include object identification information about static objects, such as walls and doors, and movable objects, such as flowerpots, chairs and desks. In addition, the object identification information may include a name of each object, a type of each object, a distance to each object, and a location (e.g., position) of each object.

Also, the robot 100 may perform the operation or drive by controlling its driver based on the control/interaction of the user. At this time, the robot 100 may obtain intention information of the interaction according to the user's motion or spoken utterance, and perform an operation by determining a response based on the obtained intention information.

The robot 100 may provide delivery service as a delivery robot that delivers an article from a departure point to a destination. The robot 100 may communicate with the terminal 200 and the server 300 through the network 400. For example, the robot 100 may receive departure point information and destination information, set by a user through the terminal 200, from the terminal 200 and/or the server 300 through the network 400. For example, the robot 100 may transmit information, such as current location of the robot 100, an operation state of the robot 100, whether the robot has arrived at its destination (such as a preset destination), and sensing data obtained by the robot 100, to the terminal 200 and/or the server 300 through the network 400.

The terminal 200 is an electronic device operated by a user or an operator, and the user may drive an application for controlling the robot 100, or may access an application installed in an external device, including the server 300, using the terminal 200. For example, the terminal 200 may acquire target area information designated by the user through the application, and may transmit the same to the robot 100 and/or the server 300 through the network 400. The terminal 200 may receive state information of the robot 100 from the robot 100 and/or the server 300 through the network 400. The terminal 200 may provide, to the user, a function of controlling, managing, and monitoring the robot 100 through the application installed therein.

The terminal 200 may include a communication terminal capable of performing the function of a computing device. The terminal 200 may be a desktop computer, a smartphone, a laptop computer, a tablet PC, a smart TV, a mobile phone, a personal digital assistant (PDA), a media player, a micro server, a global positioning system (GPS) device, an electronic book terminal, a digital broadcasting terminal, a navigation device, a kiosk, an MP3 player, a digital camera, an electrical home appliance, or any other mobile or non-mobile computing device(s), without being limited thereto. In addition, the terminal 200 may be a wearable device having a communication function and a data processing function, such as a watch, glasses, a hair band, a ring or the like. The terminal 200 is not limited to the above, and any terminal capable of performing web browsing, via a network (e.g., the network 400), may be used without limitation.

The server 300 may be a database server that provides big data necessary to control the robot 100 and to apply various artificial intelligence algorithms and data related to control of the robot 100. The server 300 may include a web server or an application server capable of remotely controlling the robot 100 using an application or a web browser installed in the terminal 200.

Artificial intelligence refers to a field of studying artificial intelligence or a methodology for creating the same. Moreover, machine learning refers to a field of defining various problems dealing in an artificial intelligence field and studying methodologies for solving the same. In addition, machine learning may be defined as an algorithm for improving performance with respect to a task through repeated experience with respect to the task.

An artificial neural network (ANN) is a model used in machine learning, and may refer in general to a model with problem-solving abilities, composed of artificial neurons (nodes) forming a network by a connection of synapses. The ANN may be defined by a connection pattern between neurons on different layers, a learning process for updating model parameters, and an activation function for generating an output value.

The ANN may include an input layer, an output layer, and may selectively include one or more hidden layers. Each layer includes one or more neurons, and the artificial neural network may include synapses that connect the neurons to one another. In an ANN, each neuron may output a function value of an activation function with respect to the input signals inputted through a synapse, weight, and bias.

A model parameter refers to a parameter determined through learning, and may include weight of synapse connection, bias of a neuron, and the like. Moreover, hyperparameters refer to parameters which are set before learning in a machine learning algorithm, and include a learning rate, a number of iterations, a mini-batch size, an initialization function, and the like.

The objective of training an ANN is to determine a model parameter for significantly reducing a loss function. The loss function may be used as an indicator for determining an optimal model parameter in a learning process of an artificial neural network.

The machine learning may be classified into supervised learning, unsupervised learning, and reinforcement learning depending on the learning method.

Supervised learning may refer to a method for training an artificial neural network with training data that has been given a label. In addition, the label may refer to a target answer (or a result value) to be guessed by the artificial neural network when the training data is inputted to the artificial neural network. Unsupervised learning may refer to a method for training an artificial neural network using training data that has not been given a label. Reinforcement learning may refer to a learning method for training an agent defined within an environment to select an action or an action order for maximizing cumulative rewards in each state.

Machine learning of an artificial neural network implemented as a deep neural network (DNN) including a plurality of hidden layers may be referred to as deep learning, and the deep learning is one machine learning technique. Hereinafter, the meaning of machine learning includes deep learning.

The network 400 may serve to connect the robot 100, the terminal 200, and the server 300 to each other. The network 400 may include a wired network such as a local area network (LAN), a wide area network (WAN), a metropolitan area network (MAN), or an integrated service digital network (ISDN), and a wireless network such as a wireless LAN, a CDMA, Bluetooth®, or satellite communication, but the present disclosure is not limited to these examples. The network 400 may send and receive information by using the short distance communication and/or the long distance communication. The short distance communication may include Bluetooth®, radio frequency identification (RFID), infrared data association (IrDA), ultra-wideband (UWB), ZigBee, and wireless fidelity (Wi-Fi) technologies, and the long distance communication may include code division multiple access (CDMA), frequency division multiple access (FDMA), time division multiple access (TDMA), orthogonal frequency division multiple access (OFDMA), and single carrier frequency division multiple access (SC-FDMA).

The network 400 may include a connection of network elements such as a hub, a bridge, a router, a switch, and a gateway. The network 400 may include one or more connected networks, for example, a multi-network environment, including a public network such as an Internet and a private network such as a safe corporate private network. Access to the network 400 may be provided through one or more wire-based or wireless access networks. Further, the network 400 may support 5G communications and/or an Internet of things (IoT) network for exchanging and processing information between distributed components such as objects.

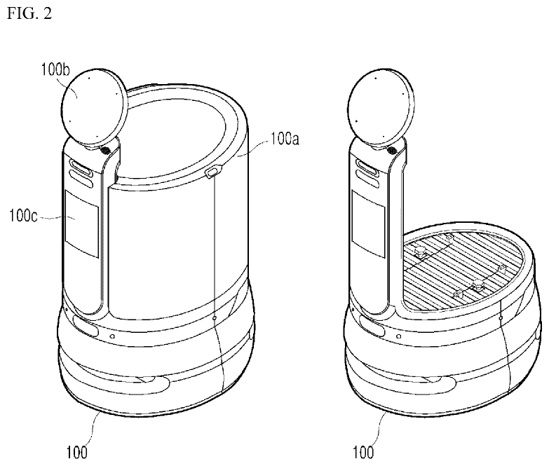

FIG. 2 is a perspective view of the robot 100 according to an embodiment. FIG. 2 illustratively shows the external appearance of the robot 100. The robot 100 may include various structures capable of accommodating an article.

In FIG. 2 the robot 100 may include a container 100a. The container 100a may be separated from a main body of the robot, and may be coupled to the main body by a fastener, such as a bolt, screw, pin, or the like. In an example, the container 100a may be formed integrally with the main body. Here, the container 100a may include a space (e.g., an interior space) for accommodating (e.g., storing) an article, and the container may include one or a plurality of walls. The one or a plurality of walls of the container 100a form the interior space of the container 100a.

Further, the container 100a may include a plurality of accommodation spaces as required.

The article accommodation method of the robot 100 is not limited to a method in which an article is accommodated in the accommodation space or spaces of the container 100a. For example, the robot 100 may transport an article using a robot arm holding the article. In this case, the container 100a may include various accommodation structures including such a robot arm.

A lock may be mounted to the container 100a. The robot 100 may lock or unlock the lock of the container 100a depending on the driving state of the robot 100 and the accommodation state of the article. For example, the lock may be a mechanical and/or an electronic/electromagnetic lock, without being limited thereto. The robot 100 may store and manage information indicating whether the container 100a is locked or unlocked, and may share the same with other devices.

The robot 100 may include at least one display. In FIG. 2, displays 100b and 100c are illustratively disposed at the main body of the robot 100, but may be disposed at other positions on the main body or outside the container 100a. In one example, the displays 100b and 100c may be provided so as to be formed integrally with the robot 100 and/or to be detachably attached to the robot 100.

The robot 100 may include a first display 100b and a second display 100c. For example, the robot 100 may output a user interface screen via the first display 100b. The robot 100 may also, for example, output a message, such as an alarm message, through the second display 100c.

FIG. 2 illustrates the main body of the robot 100. FIG. 2 shows the external appearance of the robot 100, from which the container 100a is separated, for reference.

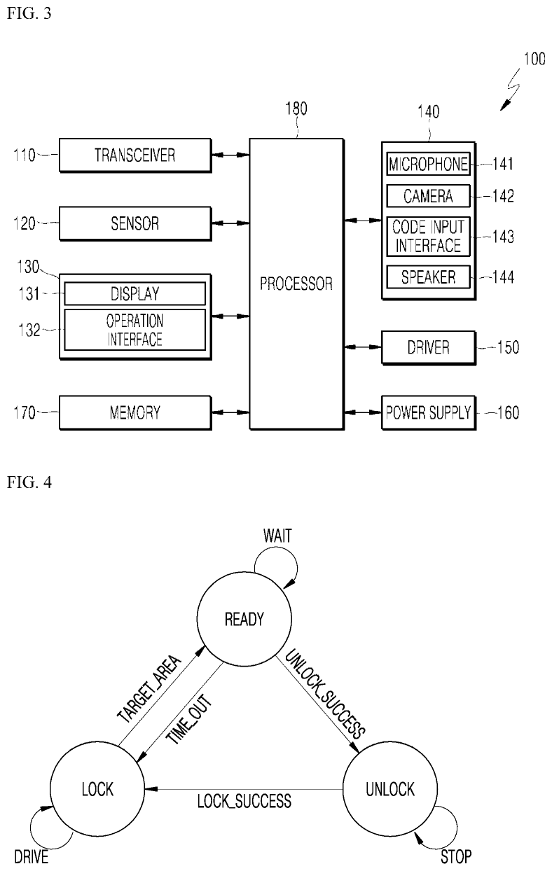

FIG. 3 is a block diagram of a robot according to an embodiment.

The robot 100 may include a transceiver 110, a sensor 120, a user interface 130, an input and output interface 140, a driver 150, a power supply 160, a memory 170, and a processor 180. The elements shown in FIG. 3 are not essential in realizing the robot 100, and the robot 100 according to the embodiment may include a larger or smaller number of elements than the above elements.

The transceiver 110 may transmit and receive data to and from external devices, such as another AI device or the server, using wired and wireless communication technologies. For example, the transceiver 110 may transmit and receive sensor information, user input, a learning model, and a control signal to and from the external devices. The AI device may also, for example, be realized by a stationary or a mobile device, such as a TV, a projector, a mobile phone, a smartphone, a desktop computer, a laptop computer, a digital broadcasting terminal, a personal digital assistant (PDA), a portable multimedia player (PMP), a navigation device, a tablet PC, a wearable device, a set top box (STB), a DMB receiver, a radio, a washer, a refrigerator, digital signage, a robot, or a vehicle.

In this case, the communications technology used by the communicator 110 may be technology such as global system for mobile communication (GSM), code division multi access (CDMA), long term evolution (LTE), 5G, wireless LAN (WLAN), Wireless-Fidelity (Wi-Fi), Bluetooth™, radio frequency identification (RFID), infrared data association (IrDA), ZigBee™, and near field communication (NFC).

The transceiver 110 is linked to the network 400 to provide a communication interface necessary to provide transmission and reception signals between the robot 100 and/or the terminal 200 and/or the server 300 in the form of packet data. Furthermore, the transceiver 110 may be a device including hardware and software required for transmitting and receiving signals, such as a control signal and a data signal, via a wired or wireless connection, to another network device. Furthermore, the transceiver 110 may support a variety of object-to-object intelligent communication, for example, Internet of things (IoT), Internet of everything (IoE), and Internet of small things (IoST), and may support, for example, machine to machine (M2M) communication, vehicle to everything (V2X) communication, and device to device (D2D) communication.

The transceiver 110 may transmit, to the server 300, space identification data acquired by the sensor 120 under the control of the processor 180, and may receive, from the server 300, space attribute information about a space in which the robot 100 is currently located in response thereto. The robot 100 may determine, under the control of the processor 180, whether the robot 100 has entered a target area (near the destination) based on the received spatial attribute information. In another example, the transceiver 110 may transmit the space identification data, acquired by the sensor 120, to the server 300 under the control of the processor 180, and may receive information about whether the robot 100 has entered the target area in response thereto.

The sensor 120 may acquire at least one of internal information of the robot 100, surrounding environment information of the robot 100, or user information by using various sensors. The sensor 120 may provide the robot 100 with space identification data allowing the robot 100 to create a map based on simultaneous location and mapping (SLAM) and to confirm the current location of the robot 100. SLAM refers to simultaneously locating the robot and mapping the environment (surrounding area of the robot).

Specifically, the sensor 120 may sense external space objects to create a map. The sensor 120 may calculate vision information of objects, such as an outer dimensions of the objects, from among the external space objects, that can become features in order to store the vision information, together with location information, on the map. In this case, the vision information is space identification data for identifying the space, and may be provided to the processor 180.

The sensor 120 may include a vision sensor, a lidar sensor, a depth sensor, and a sensing data analyzer.

The vision sensor captures images of objects around the robot. For example, the vision sensor may include an image sensor. Some of the image information captured by the vision sensor is converted into vision information having a feature point necessary to set the location. The image information refers to information that has color by pixels, and the vision information refers to meaningful content that is extracted from the image information. The space identification data that the sensor 120 provides to the processor 180 includes the vision information.

The sensing data analyzer may provide, to the processor 180, additional information created by adding information, about a specific letter, a specific figure, or a specific color to the image information calculated by the vision sensor. The space identification data that the sensor 120 provides to the processor 180 may include such additional information. In one example, the processor 180 may perform the function of the sensing data analyzer.

The lidar sensor transmits a laser signal and provides the distance and material of an object that reflects the laser signal. Based thereon, the robot 100 may recognize the distances, locations, and directions of objects sensed by the lidar sensor in order to create a map.

When SLAM technology is applied, the lidar sensor calculates sensing data allowing a map about a surrounding space to be created. When the created sensing data is stored in the map, the robot 100 may recognize its own location on the map.

The lidar sensor may provide a pattern, such as time difference or signal intensity, of the laser signal reflected by an object to the sensing data analyzer, and the sensing data analyzer may provide the distance and characteristic information of the sensed object to the processor 180. The space identification data that the sensor 120 provides to the processor 180 may include the distance and characteristic information of the sensed object.

The depth sensor also calculates the depth (distance information) of objects around the robot. In particular, during conversion of the image information, captured by the vision sensor, into vision information, the depth information of the object is included in the vision information. The space identification data may include the distance information and/or the vision information of the sensed object.

The sensor 120 may include auxiliary sensors, including an ultrasonic sensor, an infrared sensor, and a temperature sensor, but is not limited thereto, in order to assist the above sensors or increase the accuracy of sensing.

The sensor 120 may acquire various kinds of data, such as learning data for model learning and input data used when an output is acquired using a learning model. The sensor 120 may obtain raw input data. In this case, the processor 180 or the learning processor may extract an input feature by preprocessing the input data.

A display 131 in the user interface 130 may output the driving state of the robot 100 under the control of the processor 180. In one example, the display 131 may form an interlayer structure together with a touch pad in order to constitute a touchscreen. In this case, the display 131 may be used as an operation interface 132 capable of inputting information through a touch of a user. To this end, the display 131 may be configured with a touch-sensitive display controller or other various input and output controllers. The touch recognition display controller may provide an output interface and an input interface between the robot 100 and the user. The touch recognition display controller may transmit and receive electrical signals to and from the processor 180. Also, the touch recognition display controller may display a visual output to the user, and the visual output may include text, graphics, images, video, and a combination thereof. The display 131 may be a predetermined display member, such as a touch-sensitive organic light emitting display (OLED), liquid crystal display (LCD), or light emitting display (LED).

An operation interface 132 in the user interface 130 may be provided with a plurality of operation buttons and may transmit a signal corresponding to an inputted button to the processor 180. This operation interface 132 may be configured with a sensor, a button, or a switch structure, capable of recognizing a touch or pressing operation of the user to the display 131. The operation interface 132 may transmit an operation signal by a user operation in order to confirm or change various kinds of information related to driving of the robot 100 displayed on the display 131.

The display 131 may output a user interface screen for interaction between the robot 100 and the user, by control of the processor 180. For example, when the robot 100 enters the target area and switches to a ready to unlock mode, the display 131 may display a lock screen under the control of the processor 180.

The display 131 may output a message depending on a loading state of the container 100a under the control of the processor 180. That is the display 131 may display a message indicating whether or not the container 100a is loaded onto the robot 100. The robot 100 may decide a message to be displayed on the display 131 depending on a loading state of the container 100a under the control of the processor 180. For example, when the robot 100 drives with an article loaded in the container 100a, the robot 100 may display a message of “transporting” on the display 131 under the control of the processor 180.

The display 131 may include a plurality of displays. For example, the display 131 may include a display 100b for displaying a user interface screen (see FIG. 2) and a display 100c for displaying a message (see FIG. 2).

The input and output interface 140 may include an input interface for acquiring input data and an output interface for generating output related to visual sensation, aural sensation, or tactile sensation.

The input interface may acquire various kinds of data. The input interface may include a camera 142 for inputting an image signal, a microphone 141 for receiving an audio signal (e.g., audio input), and a code input interface 143 for receiving information from the user. Here, the camera 142 or the microphone 141 may be regarded as a sensor, and therefore a signal acquired from the camera 142 or the microphone 141 may be sensing data or sensor information.

The input interface may acquire various kinds of data, such as learning data for model learning and input data used when an output is acquired using a learning model. The input interface may acquire raw input data. In this case, the processor 180 or a learning processor may extract an input feature point from the input data as preprocessing.

The output interface may include a display 131 for outputting visual information, a speaker 144 for outputting aural information, and a haptic module for outputting tactile information.

The driver 150 is a module which drives the robot 100 and may include a driving mechanism and a driving motor which moves the driving mechanism. In addition, the driver 150 may further include a door driver for driving a door of the container 100a under the control of the processor 180.

The power supply 160 is supplied with external power, such as 120V or 220V alternating current (AC) and internal power, via a battery and/or capacitor, to supply the power to each component of the robot 100, under the control of the processor 180. The battery may be an internal (fixed) battery or a replaceable battery. The battery may be charged by a wired or wireless charging method and the wireless charging method may include a magnetic induction method or a self-resonance method.

The processor 180 may control the robot such that, when the battery of the power supply is insufficient to perform delivery work, the robot 100 moves to a designated charging station in order to charge the battery.

The memory 170 may include magnetic storage media or flash storage media, without being limited thereto. The memory 170 may include an internal memory and/or an external memory and may include a volatile memory such as a DRAM, a SRAM or a SDRAM, and a non-volatile memory, such as one-time programmable ROM (OTPROM), a PROM, an EPROM, an EEPROM, a mask ROM, a flash ROM, a NAND flash memory or a NOR flash memory, a flash drive such as a solid state drive (SSD), a compact flash (CF) card, an SD card, a Micro-SD card, a Mini-SD card, an XD card, a memory stick, or a storage device, such as a hard disk drive (HDD).

The memory 170 may store data supporting various functions of the robot 100. For example, the memory 170 may store input data acquired by the sensor 120 or the input interface, learning data, a learning model, and learning history. For example, the memory 170 may store map data.

The processor 180 is a type of a central processor unit which may drive control software provided in the memory 170 to control overall operation of the robot 100. The processor 180 may include all types of devices capable of processing data. Here, the processor 180 may, for example, refer to a data processing device embedded in hardware, which has physically structured circuitry to perform a function represented by codes or instructions contained in a program. As examples of the data processing device embedded in hardware, a microprocessor, a central processor (CPU), a processor core, a multiprocessor, an application-specific integrated circuit (ASIC), a field programmable gate array (FPGA), and the like may be included, but the scope of the present disclosure is not limited thereto.

The processor 180 may determine at least one executable operation of the robot 100, based on information determined or generated using a data analysis algorithm or a machine learning algorithm. In addition, the processor 180 may control components of the robot 100 to perform the determined operation.

To this end, the processor 180 may request, retrieve, receive, or use data of the learning processor or the memory 170, and may control components of the robot 100 to execute a predicted operation or an operation determined to be preferable of the at least one executable operation.

When connection with an external device is needed to perform a determined operation, the processor 180 may generate a control signal for controlling the external device and may transmit the generated control signal to the external device.

The processor 180 obtains intent information about user input, and may determine a requirement of a user based on the obtained intent information.

The processor 180 may obtain intent information corresponding to user input by using at least one of a speech to text (STT) engine for converting voice input into a character string or a natural language processing (NLP) engine for obtaining intent information of a natural language. That is, the NLP engine may derive intent information from a natural language audio input from a user, which is received by the microphone 141.

In an embodiment, the at least one of the STT engine or the NLP engine may be composed of artificial neural networks, some of which are trained according to a machine learning algorithm. In addition, the at least one of the STT engine or the NLP engine may be trained by the learning processor 330, trained by a learning processor 330 of a server 300 or trained by distributed processing thereof.

The processor 180 may collect history information including about operation of the robot 100 or user feedback about the operation of the robot 100, may store the same in the memory 170 or the learning processor 330, or may transmit the same to an external device, such as the server 300. The collected history information may be used to update an object recognition model.

The processor 180 may control at least some of the elements of the robot 100 in order to drive an application program stored in the memory 170. Furthermore, the processor 180 may combine and operate two or more of the elements of the robot 100 in order to drive the application program.

The processor 180 may control the display 131 in order to acquire target area information designated by the user through the user interface screen displayed on the display 131.

The processor 180 may control opening and closing of the container 100a depending on the operation mode. The processor 180 may determine whether the robot has entered a target area capable of unlocking the container 100a based on the space identification data acquired by the sensor 120. When the robot 100 has entered the target area, the processor 180 may set the operation mode to a ready to unlock mode. When the operation mode is a ready to unlock mode, the processor 180 may cause the robot 100 to stop traveling and to wait until the user arrives.

The robot 100 may include a learning processor 330.

The learning processor 330 may train an object recognition model constituted by an artificial neural network using learning data. Here, the trained artificial neural network may be referred to as a learning model. The learning model may be used to infer a result value with respect to new input data rather than learning data, and the inferred value may be used as a basis for a determination for performing an operation.

The learning processor may perform AI processing together with the learning processor 330 of the server 300.

The learning processor 330 may be realized by an independent chip or may be included in the processor 180.

The learning processor 330 may include a memory that is integrated into the robot 100 or separately implemented. Alternatively, the learning processor may be implemented using the memory 170, an external memory directly coupled to the robot 100, or a memory maintained in an external device.

FIG. 4 is a diagram showing switching between operation modes of the robot according to the embodiment.

The robot 100 may be locked in order to prevent a loaded article from being stolen or lost. Here, locking of the robot 100 refers to locking of the lock of the container 100a. The user may load an article in the container 100a of the robot 100 and may set the container 100a to be locked. A recipient may unlock the container 100a after an authentication process. The authentication process for unlocking includes a process of inputting a predetermined password or biometric information in order to determine whether the user has a right to access the container. The user may unlock the robot 100 only after such an authentication process. Here, the user may include various subjects that interact with the robot 100. For example, the user may include a subject that instructs the robot 100 to deliver an article or a subject that receives the article, and is not limited to a person and may be another intelligent robot 100.

The robot 100 may change the locked state of the container 100a depending on the operation mode. In an example, the operation mode may include a lock mode, an unlock mode, and a ready to unlock mode. The robot 100 decides the operation mode and stores the decided operation mode in the memory 170 under the control of the processor 180. In another example, the operation mode may be decided by the container of the robot 100. In an example, the operation mode may be decided by the robot 100.

Hereinafter, switching between operation modes of the robot 100 based on an article delivery process will be described with reference to FIG. 4.

A user who wishes to deliver an article using a robot 100 calls for a robot 100, and an available robot 100 among a plurality of robots 100 is assigned to the user. Here, the available robot 100 includes a robot 100 having an empty container 100a or a robot without a container 100a (an idle robot). The user may directly transmit a service request to the robot 100 using a terminal 200 of the user, such as a mobile terminal (e.g., cell phone, or the like), or may transmit the service request to the server 300. Alternatively, the user may call a robot 100 near the user using a voice command, which is received via the microphone 141 of the robot 100.

When the container 100a of the robot 100 is empty or the robot 100 is idle, the robot sets the operation mode of the robot 100 having the empty container 100a or the idle robot 100 to an unlock mode under the control of the processor 180.

The robot 100 called according to the service request of the user opens the empty container 100a according to a voice command of the user or an instruction acquired through the user interface 130, and closes the container 100a after the user loads an article in the container 100a. In an example, the robot 100 may determine whether an article is loaded in the container 100a using a weight sensor, and may determine the weight of the loaded article. That is, the robot 100 or the container 100a may comprise a weight sensor for determining whether an article is loaded in the container 100a.

When the user loads the article in the container 100a of the robot 100 and sets the container 100a to be locked, the robot 100 sets the operation mode of the container 100a having the article loaded therein to a lock mode. For example, the user may instruct the container 100a having the article loaded therein to be locked through a voice command or the user interface screen displayed on the display 131. The user may also, for example, instruct the container 100a to be locked through the terminal 200.

The robot 100 may operate the lock of the container 100a having the article loaded therein to put the container 100a in a locked state according to the locking instruction under the control of the processor 180. For example, the lock may be a mechanical and/or an electronic/electromagnetic lock, without being limited thereto.

When the container 100a is set to a lock state (LOCK SUCCESS), the robot 100 may set the operation mode of the container 100a to a lock mode (LOCK MODE).

In order to deliver the loaded article, the robot 100 starts to drive to a destination (DRIVE). The robot 100 maintains the lock mode while driving in with the article loaded in the container 100a. As a result, it is possible to prevent the loaded article from being lost or stolen and to safely deliver a dangerous article or an important article.

During driving, the robot 100 acquires space identification data using the sensor 120. The robot 100 may collect and analyze the space identification data under the control of the processor 180 in order to decide the current location of the robot 100 and to determine whether the robot 100 has entered a target area.

When the robot 100 enters the target area (TARGET_AREA), the robot 100 stops driving and switches the operation mode from the lock mode to a ready to unlock mode. In the ready to unlock mode, the robot 100 waits for a user (WAIT). The robot 100 maintains the ready to unlock mode until the user approaches and completes an authentication process for unlocking.

In the ready to unlock mode, the robot 100 may transmit an arrival notification message to the terminal 200 and/or the server 300, by the network 400 or by wired communication. For example, the arrival notification message may include current location information of the robot 100. The robot 100 may, for example, periodically transmit the arrival notification message while waiting for the user.

The user may recognize that the robot 100 has arrived at the target area through a notification message received by the terminal 200. In the ready to unlock mode, the robot 100 provides a user interface screen allowing the user to unlock the container 100a through the display 131.

When the user recognizes that the robot 100 has entered the target area, the user may directly move to the waiting robot 100 in order to receive the article. Consequently, it is possible to prevent a decrease in the driving speed of the robot 100, which occurs when a plurality of people or obstacles is present near the destination, and thus to reduce delay time required to accurately arrive at the destination due to collision-avoidance driving. Accordingly, the present invention may improve user convenience by delivery an article to a desired location, including in an urgent matter.

When the user has not arrived at the waiting robot and a predetermined time elapses (TIME_OUT), after the robot 100 has entered the target area, the robot 100 may switch the operation mode to a lock mode again. The robot 100 may transmit an arrival notification message to the terminal 200 and/or the server 300. In an example, when the user has not arrived after a predetermined time has elapsed after the robot 100 has entered the target area, the robot 100 may switch the operation mode to a lock mode and may move to a departure point or a predetermined ready zone. In this case, the robot 100 may transmit a return notification message or a ready notification message to the terminal 200 and/or the server 300.

When the robot is in the ready mode and the user approaches the robot 100 and successfully performs an authentication process, such as input of a password, the robot 100 ends the ready mode and switches the operation mode to an unlock mode.

In the unlock mode, the robot unlocks the container 100a. The robot 100 stops driving and maintains the unlock mode while the user takes the article out of the unlocked container 100a.

When the user completes reception of the article, the robot 100 moves to another destination or a predetermined ready zone. In this case, the robot 100 may drive with the empty container 100a set to an unlock mode.

The robot 100 that is returning after completion of delivery may drive with the operation mode set to an unlock mode. The robot 100 that is returning may drive with the operation mode set to a lock mode. In this case, it is possible to unlock the returning robot 100 anywhere.

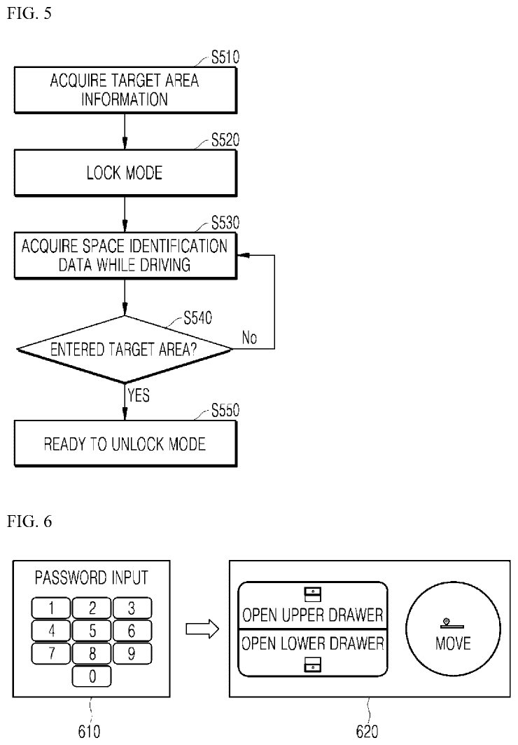

FIG. 5 is a flowchart of a robot control method according to an embodiment.

The robot control method may include a step of acquiring target area information of a target area capable of unlocking the container (S510), a step of locking the container and setting the operation mode of the robot 100 to a lock mode (S520), a step of sensing space identification data while the robot is driving based on route information from a departure point to a destination (S530), a step of determining whether the robot 100 has entered the target area based on the space identification data (S540), and a step of setting the operation mode to a ready to unlock mode upon determining that the robot 100 has entered the target area (S550).

At step S510, the robot 100 may acquire target area information under the control of the processor 180.

At step S510, the robot 100 may acquire target area information set by a user.

The target area is an area including the destination, and means an area in which the user is capable of unlocking the container 100a. The target area information means information necessary for the robot 100 to specify the target area from a map stored in the memory 170. For example, the target area information includes information about a planar or cubic space defined as space coordinates in the map or space identification data. As described above with reference to FIG. 3, the robot 100 switches the operation mode to a ready to unlock mode while in the target area.

At step S510, the robot 100 may receive target area information set by the user from the terminal 200 or the server 300 through the transceiver 110, may acquire target area information selected by the user from an indoor map expressed through the display 131, or may acquire target area information designated by the user using voice input through the microphone 141, under the control of the processor 180.

Optionally, the user may designate departure point information and destination information. For example, the user may designate the departure point and the destination through the terminal 200 or on the display 131 of the robot, or may transmit the destination to the robot 100 by voice input through the microphone 141.

At step S510, the robot 100 may create route information based on the acquired departure point information and destination information. In an example, the robot 100 may create the route information based on identification information of the target area.

As step S520, the robot 100 may lock the container 100a and may set the operation of the robot 100 to a lock mode under the control of the processor 180.

At step S520, when the user puts an article in the container 100a, the robot 100 closes (e.g., automatically closes) the door of the container 100a, locks the container 100a, sets the operation mode to a lock mode, and starts to deliver the article under control of the processor 180. In an example, the robot 100 may transmit a departure notification message to a terminal 200 of a user who will receive the article or the server 300 under the control of the processor 180.

In an example, the display 131 may have a structure that is rotatable, including rotatable leftwards, rightwards, upwards, and downwards. For example, when the operation mode of the robot 100 is a lock mode, the robot 100 may rotate the display 131 so as to face the direction in which the robot 100 drives under the control of the processor 180.

At step S530, the robot 100 may acquire space identification data through the sensor 120 while driving, based on route information from the departure point to the destination under the control of the processor 180.

That is, at step S530, the robot 100 may acquire space identification data of a space through which the robot 100 passes while driving based on the route information using the sensor 120. As described above with reference to FIG. 3, the space identification data may include vision information, location information, direction information, and distance information of an object disposed in the space. The robot 100 may use the space identification data as information for determining the current location of the robot 100 in relation to the map stored in the memory 170.

At step S540, the robot 100 may determine whether the robot 100 has entered a target area based on the space identification data acquired at step S530 under control of the processor 180.

Hereinafter, a method of determining whether the robot has entered the target area at step S540 according to each embodiment will be described.

According to a first embodiment, at step S540, the robot 100 may determine whether the robot 100 has entered the target area based on the current location information thereof.

In the first embodiment, step S540 may include a step of determining the current location of the robot 100 based on the space identification data and a step of determining that the robot 100 has entered the target area when the current location is mapped to the target area.

The robot 100 may decide a current location of the robot 100 based on the space identification data acquired at step S530 under the control of the processor 180. For example, the robot 100 may decide the current location by comparing the space identification data acquired through the sensor 120 with the vision information stored in the map under the control of the processor 180.

The robot 100 may determine that the robot has entered the target area when the decided current location is mapped to a target area specified in the map by the target area information acquired at step S510.

In a second embodiment, at step S540, the robot 100 may determine whether the robot has entered the target area based on reference distance information.

Step S540 may include a step of determining the current location of the robot based on the space identification data and a step of deciding on the distance between the current location and the destination and, when the distance between the current location and the destination is within a predetermined reference distance, determining that the robot 100 has entered the target area.

The robot 100 may decide the current location of the robot 100 based on the space identification data acquired at step S530 under the control of the processor 180. This may be performed in the same manner as at the aforementioned step of determining the current location of the robot 100 based on the space identification data.

The robot 100 may calculate the distance between the decided current location and the destination and, when the distance between the current location and the destination is within a predetermined reference distance, may determine that the robot 100 has entered the target area. Here, the reference distance may be adjusted depending on factors such as congestion of the target area and delivery time zone. For example, when many people or obstacles are present in the target area, the reference distance may be set to a longer distance. For example, when the delivery time zone is a rush hour zone, the reference distance may be set to a shorter distance.

In a third embodiment, at step S540, the robot 100 may determine whether the robot has entered the target area based on a spatial attribute.

Step S540 may include a step of determining a spatial attribute of a place in which the robot 100 is driving based on the space identification data and a step of determining whether the robot 100 has entered the target area based on the spatial attribute.

The robot 100 may decide a spatial attribute of a place in which the robot 100 is driving based on the space identification data acquired at step S530 under control of the processor 180. In an example, the spatial attribute may include an input feature point extracted from the space identification data.

The robot 100 may determine whether the robot 100 has entered the target area based on the decided spatial attribute.

The robot 100 may determine whether the robot 100 has entered the target area based on the decided spatial attribute using an object recognition model based on an artificial neural network under the control of the processor 180. In an example, the object recognition model may be trained using the space identification data acquired using the sensor 120 of the robot 100 as learning data. The object recognition model may be trained under the control of the processor of the robot 100 or may be trained in the server 300, and may be provided to the robot 100.

For example, when the destination of a robot 100 providing a delivery service at a hospital is a blood collection room, the robot 100 may determine that the robot has entered the blood collection room through the object recognition model using space identification data including a surrounding image acquired in a place in which the robot 100 is driving at step S540 as input.

At step S540, the robot 100 may perform one or more of the first embodiment, the second embodiment, and the third embodiment in order to determine whether the robot 100 has entered the target area. The first embodiment, the second embodiment, and the third embodiment are named in order to distinguish therebetween, and do not limit the sequence or priority of the embodiments.

At step S550, the robot 100 may set the operation mode to a ready to unlock mode under the control of the processor 180 when the robot 100 has entered the target area at step S540.

Upon determining at step S540 that the robot 100 has not entered the target area, step S530 may be continuously performed. In this case, the robot 100 maintains the lock mode.

Meanwhile, the robot control method may, when the robot 100 has entered the target area at step S540, further include a step of transmitting a notification message to an external device through the transceiver 110 under the control of the processor 180.

For example, when the robot 100 has entered the target area. The robot 100 may transmit a notification message to the terminal 200 and/or the server 300 through the transceiver 110 under the control of the processor 180. The robot 100 may also, for example, repeatedly transmit the notification message to the terminal 200 and/or the server 300 while waiting, in a ready to unlock mode, for the user.

The robot 100 may decide/determine a user interface screen to be displayed on the display 131 depending on the operation mode under the control of the processor 180.

The robot control method may further include a step of displaying, through the display 131, a lock screen capable of receiving input for unlocking when the operation mode is a ready to unlock mode.

FIG. 6 is a diagram showing an example of a user interface screen based on the operation mode. Element/box 610 of FIG. 6 shows a password input screen as an illustrative lock screen (i.e., a user interface screen).

After step S550 is performed and the operation mode is switched to a ready to unlock mode, the robot 100 may display a lock screen on the display 131 under the control of the processor 180. The lock screen refers to a user interface screen for performing an authentication process required in order to unlock the container 100a. For example, the authentication process may include password input, biometric information authentication including fingerprint, iris, voice, and facial recognition, tagging of RFID, barcode or QR code, agreed-upon gesture, and an electronic key, and various authentication processes capable of confirming that the user is a recipient. The authentication process may be performed through the display 131 and/or the input and output interface 140 under the control of the processor 180.

In an example, the display 131 may have a structure that is rotatable leftwards, rightwards, upwards, and downwards. For example, when the operation mode of the robot 100 is a ready to unlock mode, the robot 100 may rotate the display 131 so as to face the direction in which the container 100a is located under control of the processor 180.

In addition, the robot control method may further include a step of setting the operation mode to an unlock mode and a step of displaying, through the display 131, a menu screen capable of instructing opening and closing of the container 100a upon receiving input for unlocking.

Input for unlocking refers to user input required for the above authentication process. For example, the input for unlocking method may include password input, fingerprint recognition, iris recognition, and code tagging.

When the robot 100 receives the input for unlocking, the robot 100 may control the processor 180 to set the operation mode to an unlocking mode.

Upon successfully acquiring the input for unlocking, the robot 100 unlocks the locked container 100a and switches the operation mode to an unlocking mode under control of the processor 180. When the operation mode of the robot 100 is an unlocking mode, the robot 100 may rotate the display 131 so as to face the direction in which the container 100a is located under the control of the processor 180.

Subsequently, the unlocked robot 100 may display a menu screen that can offer instructions regarding opening and closing of the container 100a under the control of the processor 180.

FIG. 6 shows an illustrative menu screen displayed on the display 131 in an unlocking mode.

Element/box 620 of FIG. 6 illustratively shows a menu screen of a robot 100 having a structure in which the container 100a includes a plurality of drawers.

The shown menu screen includes “open upper drawer,” “open lower drawer,” and “move” in an activated state. When the user selects “open upper drawer” on the menu screen, the robot 100 may output, through the display 131, a menu screen including “close upper drawer,” “open lower drawer,” and “move” while opening the upper drawer of the container 100a. Since the upper drawer is open, the “move” item may be inactivated.

Likewise, when the user selects “open lower drawer” on the menu screen, the robot 100 may output, through the display 131, a menu screen including “close lower drawer,” “open upper drawer,” and “move” while opening the lower drawer of the container 100a. Since the lower drawer is open, the “move” item may be inactivated.

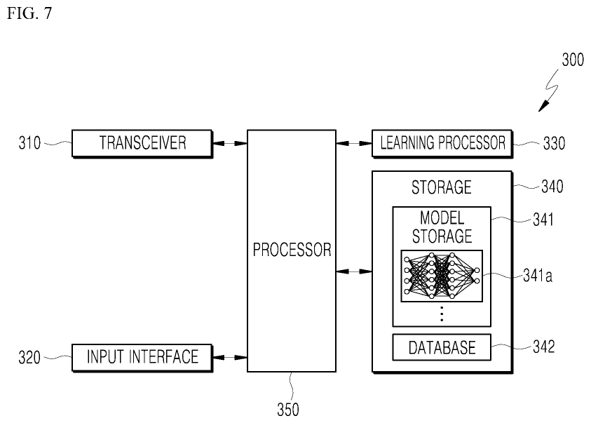

FIG. 7 is a block diagram of a server according to an embodiment.

The server 300 may refer to a control server for controlling the robot 100. The server 300 may be a central control server for monitoring a plurality of robots 100. The server 300 may store and manage state information of the robot 100. For example, the state information may include location information, operation mode, driving route information, past delivery history information, and residual battery quantity information. The server 300 may choose a robot 100 among a plurality of robot 100 to respond to a user service request. In this case, the server 300 may consider the state information of the robot 100. For example, the server 300 may decide an idle robot 100 located nearest to the user as the robot 100 to respond to the user service request.

The server 300 may refer to a device for training an artificial neural network using a machine learning algorithm or using a trained artificial neural network. Here, the server 300 may include a plurality of servers to perform distributed processing, or may be defined as a 5G network (or any other type of network as noted above). At this time, the server 300 may be included as a component of the robot 100 in order to perform at least a portion of AI processing together.

The server 300 may include a transceiver 310, an input interface 320, a learning processor 330, a storage 340, and a processor 350.

The transceiver 310 may transmit and receive data to and from an external device, such as the robot 100. For example, the transceiver 310 may receive space identification data from the robot 100 and may transmit a spatial attribute extracted from the space identification data to the robot 100 in response thereto. The transceiver 310 may transmit, to the robot 100, information about whether the robot has entered the target area.

The input interface 320 may acquire input data for AI processing. For example, the input interface 320 may include an input and output port capable of receiving data stored in an external storage medium.

The storage 340 may include a model storage 341. The model storage 341 may store a model (or an artificial neural network 341a) learning or learned through the learning processor 330. For example, the storage 340 may store an object recognition model that is being trained or has been trained.

The learning processor 330 may train the artificial neural network 341a using learning data. The learning model may be used while mounted in the server 300 of the artificial neural network, or may be used while mounted in an external device such as the robot 100, or the like.

The learning model may be implemented as hardware, software, or a combination of hardware and software. When a portion or the entirety of a learning model is implemented as software, one or more instructions, which constitute the learning model, may be stored in the storage 340.

The processor 350 may infer a result value with respect to new input data using the learning model, and generate a response or control command based on the inferred result value. For example, the processor 350 may infer a spatial attribute of new space identification data using an object recognition model, and may respond regarding whether the place in which the robot is driving is a target area.

The order of individual steps in process claims according to the present disclosure does not imply that the steps must be performed in this order; rather, the steps may be performed in any suitable order, unless expressly indicated otherwise. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations can be made depending on design conditions and factors within the scope of the appended claims or equivalents thereof.

It should be apparent to those skilled in the art that various substitutions, changes and modifications which are not exemplified herein but are still within the spirit and scope of the present disclosure may be made.

What is claimed is:

1. A robot, comprising:
a container configured to open, to close and to store an article in an interior space of the container;
a memory configured to store route information of the robot from a departure point to a destination;
a sensor configured to acquire space identification data while the robot is driving, based on the stored route information; and
a processor configured to:
control opening and closing of the container based on an operation mode of the robot,
determine whether the robot has entered a target area which includes the destination based on the space identification data; and
change the operation mode of the robot from a lock mode to a ready to unlock mode upon determining that the robot has entered the target area,
wherein, in the lock mode, the container is locked closed.

2. The robot according to claim 1, further comprising a display configured to display a user interface screen,
wherein the memory is further configured to store a map, and
wherein the processor is further configured to control the user interface screen to display an application for inputting, by a user, target area information, the target area information including a location of the target area within the map stored in the memory.

3. The robot according to claim 1, wherein the processor is further configured to:
determine a current position of the robot based on the space identification data, and
determine that the robot has entered the target area when the current position of the robot is within the target area.

4. The robot according to claim 1, wherein the processor is further configured to:
determine a current position of the robot based on the space identification data,
determine a distance between the current position of the robot and the destination, and
determine that the robot has entered the target area when the distance is within the predetermined reference distance from the destination.

5. The robot according to claim 1, wherein the processor is further configured to:
determine a spatial attribute of an area in which the robot is driving based on the space identification data, and
determine whether the robot has entered the target area based on the spatial attribute.

6. The robot according to claim 1, wherein the processor is further configured to determine whether the robot has entered the target area using an object recognition model based on an artificial neural network.

7. The robot according to claim 1, wherein the sensor comprises an image sensor, lidar sensor, or a depth sensor.

8. The robot according to claim 1, wherein, in the ready to unlock mode, the processor is configured to cause the robot to stop driving and wait until a user arrives at the robot.

9. The robot according to claim 1, wherein the processor is further configured to maintain the operation mode as the lock mode when the robot is driving with the article stored in the interior space of the container.

10. The robot according to claim 1, further comprising a display configured to display a user interface screen,
wherein, in the ready to unlock mode, the processor is further configured to control the user interface screen to display a lock screen configured to receive input for unlocking the container.

11. The robot according to claim 1, further comprising a display,
wherein the processor is further configured to control the display to display a message depending on a loading state of the container.

12. The robot according to claim 1, wherein the processor is further configured to create a notification message and to transmit the notification message to an external device when the robot has entered the target area.

13. A method of controlling a robot having a container, the method comprising:
acquiring target area information of a target area, the target area information including a location of the target area within a map stored in a memory of the robot;
locking the container and setting an operation mode of the robot to a lock mode;
driving the robot from a departure point towards the destination;
acquiring space identification data while the robot is driving from the departure point toward the destination, based on route information stored in the memory of the robot;
determining whether the robot has entered the target area based on the space identification data; and
changing the operation mode from the lock mode to a ready to unlock mode upon determining that the robot has entered the target area.

14. The method according to claim 13, wherein the step of determining whether the robot has entered the target area comprises:
determining a current position of the robot based on the space identification data; and
determining that the robot has entered the target area when the current position is within the target area.

15. The method according to claim 13, wherein the step of determining whether the robot has entered the target area comprises:
determining a current position of the robot based on the space identification data;
determining a distance between the current position and the destination; and
determining that the robot has entered the target area when the distance is within the predetermined reference distance from the destination.

16. The method according to claim 13, wherein the step of determining whether the robot has entered the target area comprises:
determining a spatial attribute of an area in which the robot is driving based on the space identification data; and
determining whether the robot has entered the target area based on the spatial attribute.

17. The method according to claim 16, wherein the step of determining whether the robot has entered the target area based on the spatial attribute comprises determining whether the robot has entered the target area using an object recognition model based on an artificial neural network.

18. The method according to claim 13, further comprising;
displaying, through a display of the robot, a lock screen when the operation mode is the ready to unlock mode; and
receiving an input, via the lock screen, for unlocking the container.

19. The method according to claim 18, further comprising:
setting the operation mode to an unlock mode upon receiving the input for unlocking the container; and
displaying a menu screen, through the display, the menu screen including a first icon for opening of the container and a second icon for closing of the container.

20. The method according to claim 13, further comprising transmitting a notification message to an external device when the robot enters the target area.
